(19) United States
(12) Patent Application Publication
(10) Pub. No.: US 2009/0016011 A1
(43) Pub. Date: Jan. 15, 2009

(54) MODULE AND A METHOD OF POSITIONING A MODULE

(75) Inventor: Adam Wade, Southsea (GB)

Correspondence Address: PILLSBURY WINTHROP SHAW PITTMAN, LLP, P.O. BOX 10500, MCLEAN, VA, 22102, US

(73) Assignee: XYRATEX TECHNOLOGY LIMITED, Havant (GB)

(21) Appl. No.: 12/167,555

(22) Filed: Jul. 3, 2008

Related U.S. Application Data
(60) Provisional application No. 60/948,594, filed on Jul. 9, 2007.

(51) Int. Cl. G06F 1/16

(52) U.S. Cl. 361/684

(57) ABSTRACT

A module receivable within a data storage device enclosure is disclosed. The module comprises a module body and a handle arranged to lever the module into or out of its received position in a said data storage device enclosure. The handle has a plastics portion that can be gripped by a user to operate the handle, and a metal portion by which the handle is attached to the module body.

This application claims the benefit of priority to U.S. application Ser. No. 60/948,594, filed Jul. 9, 2007, the content of which is hereby incorporated by reference.

The present invention relates to a module receivable within a data storage device enclosure and to a method of positioning a module into or out of a received position in a data storage device enclosure.

Data storage device enclosures known in the prior art are typically highly modular. These are commonly arranged to have data storage module bays at the front of the enclosure for receiving data storage modules, for example disk drive assemblies mounted in carriers. Other bays are positioned at the rear of the enclosure for receiving various other modules, such as power supply units, cooling modules and various electronics modules. The electronics modules typically include one or more controller modules for providing input/output connections to the enclosure and for controlling the disk drive assemblies, for example to provide “just a bunch of disks” (JBOD) functionality or “switched bunch of disks” (SBOD) functionality and/or RAID functionality. Many other layouts and configurations of data storage enclosures are possible and, indeed, available commercially.

The modules are removable from the enclosure, allowing replacement of failed modules or upgrading or changing the functionality of the enclosure. In order to aid the insertion and removal of modules from the enclosure, the modules are sometimes provided with a handle with a lever action, sometimes called a camming handle. The lever action is used to generate sufficient force to push the module home into its connector when installing the module, and to prise the module out of the connector when removing the module. A latch is often also provided to hold the handle, and hence the module, securely in place and ensure that the module cannot work loose through vibration or other causes.

As will be appreciated, when the module is received in the enclosure, only one face of the module is normally externally accessible and this face is usually required to provide space for external connectors, indicators and the like. Indeed, the enclosure may be required to conform to a set of standards, for example the Storage Bridge Bay (SBB) specification, which strictly regulates how the face of a module of a particular type is laid out. Thus there is typically little room on the external face of the module that can be used to accommodate a handle. This constrains the possible thickness of the handle.

A number of difficulties arise in manufacturing a suitable handle for such a module. As previously discussed, the handle is often required to have a small thickness so that it can be accommodated in the limited space available on the module face. At the same time, the handle needs to have high strength and stiffness to withstand the levering forces of insertion and removal. The part of the handle gripped by the user in use needs to be ergonomically suitable. Also, the handle may be required to incorporate a latch mechanism. These requirements place conflicting demands on the materials and construction of the handle. As well as all this, the handle should be preferably simple to manufacture in order to keep manufacturing costs down.

Handles made entirely from a plastics material are known in the art. However, due to the material properties of plastics, these handles must be made thick in order to have the necessary strength and stiffness. This makes these prior art handles unsuitable for use in many cases.

According to a first aspect of the present invention, there is provided a module receivable within a data storage device enclosure, the module comprising: a module body; and, a handle arranged to lever the module into or out of its received position in a said data storage device enclosure, wherein the handle has a plastics portion that can be gripped by a user to operate the handle, and a metal portion by which the handle is attached to the module body.

The metal portion provides strength and stiffness to the handle due to the material properties of the metal. The insertion forces of the module can be extremely high and therefore the metal portion helps the handle withstand the insertion forces whilst it performs the levering action. The metal portion can therefore be made thin, making it particularly suitable for modules where there is limited space for a handle. The plastics portion allows the user to avoid gripping only metal portions of the handle. An area of the handle suitable to be gripped by the user can be completely covered by plastics material, so the operator grips plastics material only, which is significantly more comfortable and ergonomically acceptable than gripping metal.

In a preferred embodiment, the module comprises: a latch formed from the plastics portion of the handle; and, a locking member on the module body, wherein with the handle in a first position relative to the module body, the handle is constrained in position by the latch latching to the locking member. This arrangement may make use of the resiliency of the plastics material to provide the latch. This aids simplicity of construction of the handle.

In a preferred embodiment, the metal portion is pivotally mounted to the module body. The metal provides the strength and stiffness needed by the handle for the levering action and to be securely fastened to the module. Using metal allows the handle to be made thin.

In a preferred embodiment, the module comprises at least one camming part on the metal portion for camming the module into or out of its received position in a said data storage device enclosure upon operation of the handle. The metal portion provides strength and stiffness to the camming part to allow it to withstand the leveraging forces needed to separate the module from the connectors on the midplane of the enclosure.

In an embodiment, the metal portion is made from sheet metal having a thickness of between about 0.5 mm and 3.5 mm. Since the metal portion is the part of the handle by which the handle is attached to the module, having a metal portion with a small thickness allows very little of the module face to be taken up in attaching the handle.

In an embodiment, the handle has an overall thickness of less than about 12.7 mm. In another embodiment, the handle has an overall thickness of less than about 4.5 mm. These embodiments allow the handle to be used with modules where there is very little space on the module face which can accommodate the handle, for example, where connectors occupy a large part of the module face.

The plastics portion may be overmoulded to the metal. This provides a simple way of making the handle using standard manufacturing techniques, and hence keeps the cost of manufacture down.

The plastics portion may be colour coded to identify the module. The handle can be manufactured with different coloured plastics to allow the module to be easily identified by a user in use.

According to a second aspect of the present invention, there is provided a method of positioning a module into or out of a received position in a data storage device enclosure, the module comprising a module body and a handle, the handle comprising a plastics portion that can be gripped by a user to operate the handle, and a metal portion by which the handle is attached to the module body, the method comprising: gripping the plastics portion; and, operating the handle to lever the module into or out of its received position in the data storage device enclosure.

Embodiments of the present invention will now be described by way of example with reference to the accompanying drawings, in which:

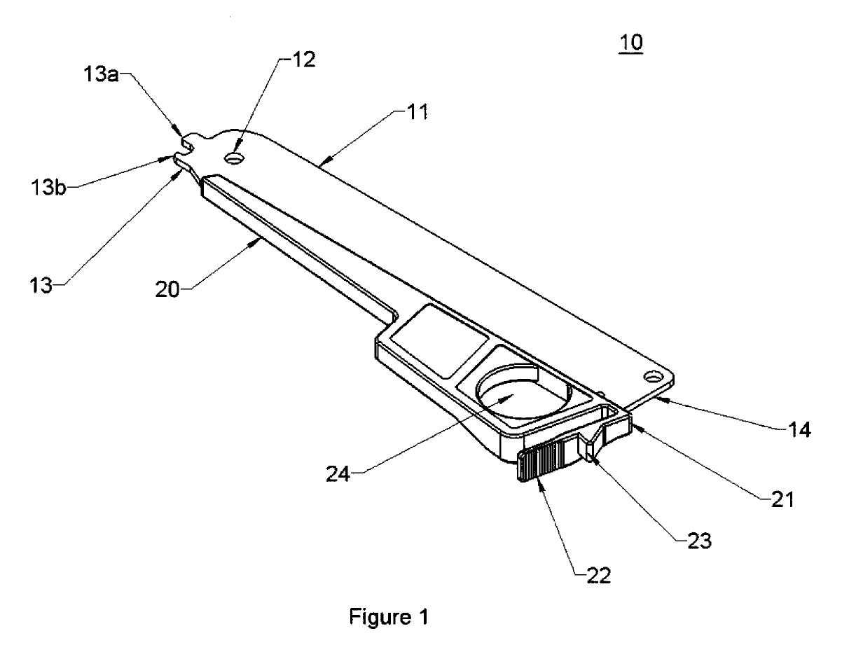

FIG. 1 shows a perspective view of an example of a handle for a module according to an embodiment of the present invention;

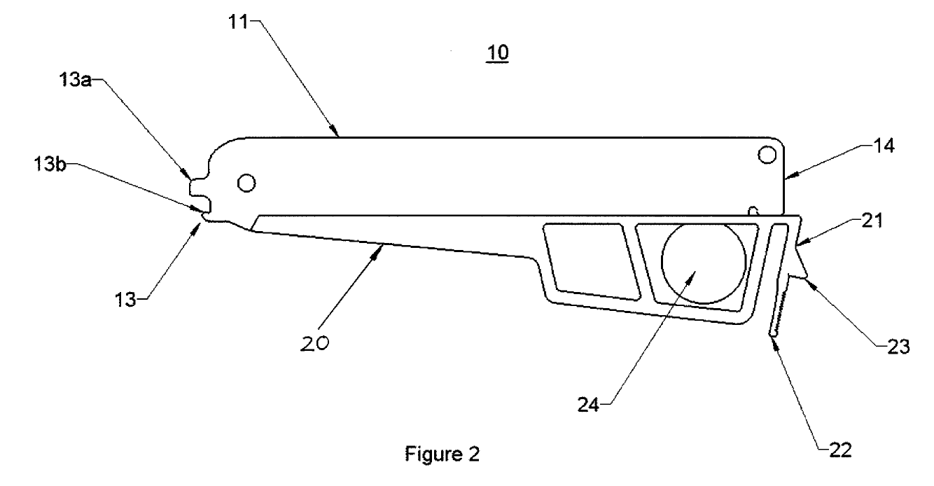

FIG. 2 shows a plan view from the top of the handle of FIG. 1;

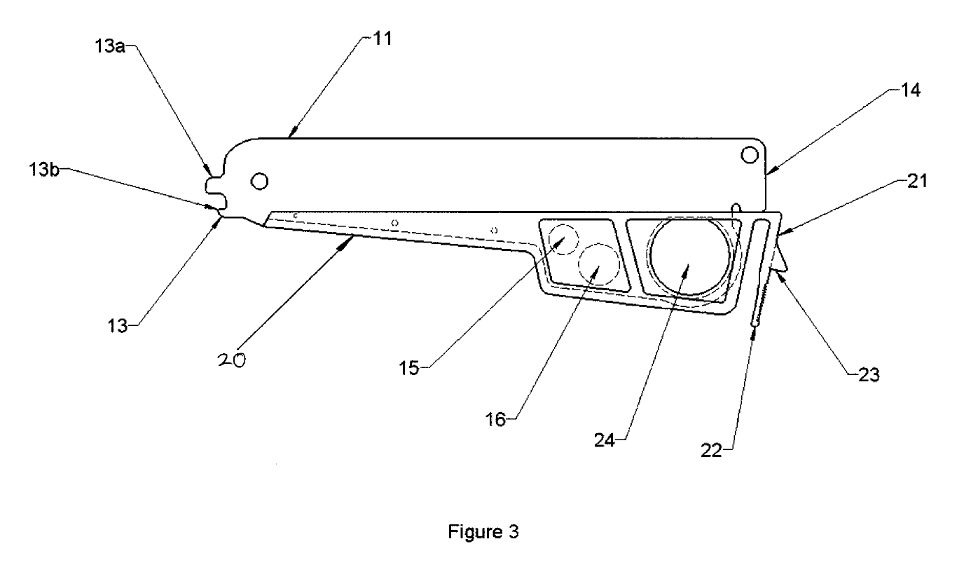

FIG. 3 shows a plan view from the top in transparency of the handle of FIG. 1;

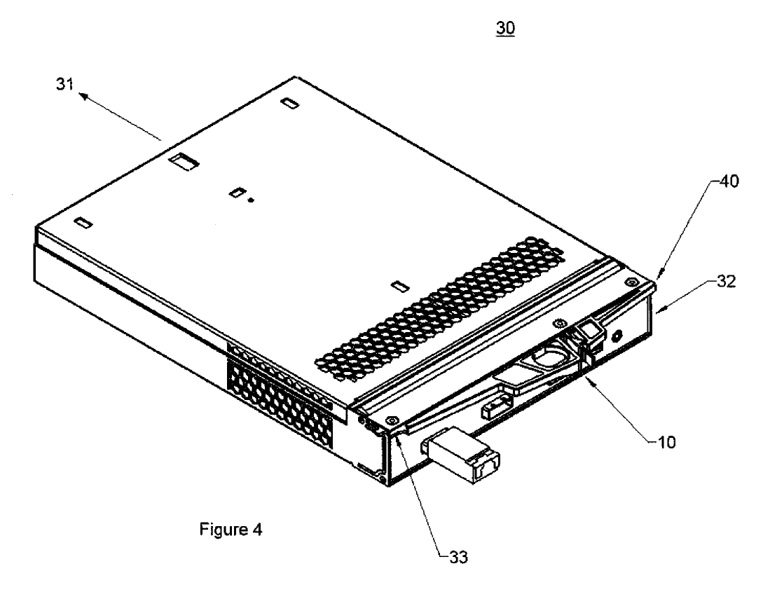

FIG. 4 shows the handle of FIG. 1 incorporated into a module for a data storage enclosure; and,

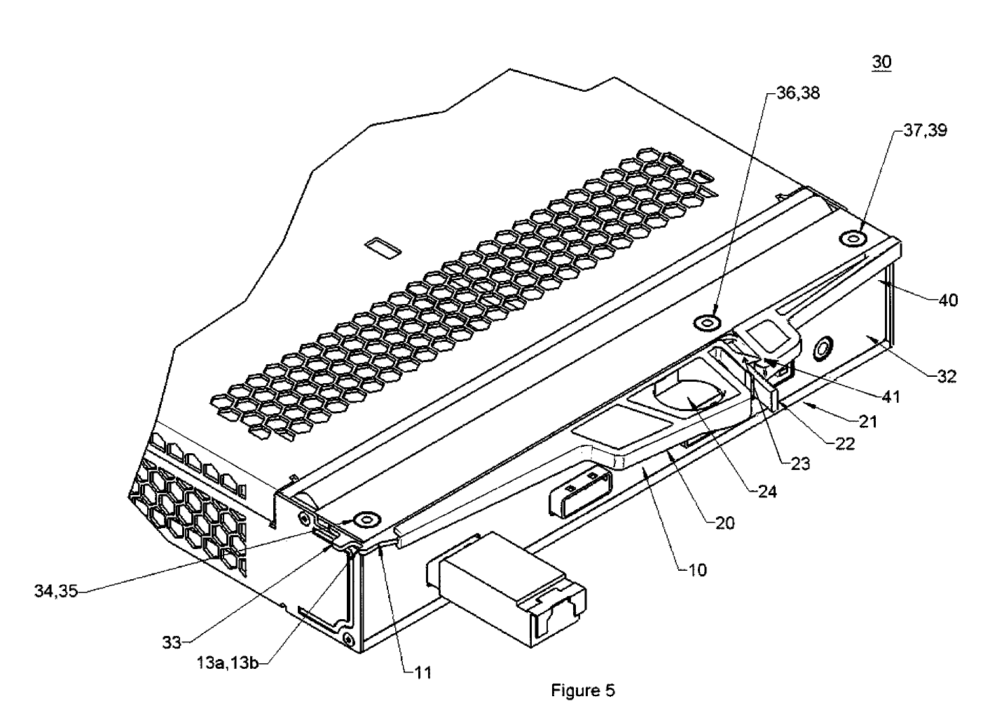

FIG. 5 shows a detail view of FIG. 4.

Referring to FIGS. 1 to 3, a handle 10 comprises a metal member 11. The metal member 11 is generally thin, elongate and flat. In the present example, the metal member 11 is manufactured by stamping sheet mild steel having a thickness of about 1.5 mm. Nonetheless, the metal member 11 may be manufactured in other ways and/or from other suitable metals, for example being cast from aluminium alloy or zinc alloy. The metal member 11 may also have a different thickness, but preferably the thickness is between about 0.5 mm and 3.5 mm. The metal member 11 has a pivot hole 12 near one end, by which the handle 10 is attachable to a module. At the extremity of the pivot end, the metal member 11 has a camming portion 13 comprising two projections 13a,13b which are used to lever or cam the module to which the handle 10 is attached in place in a storage enclosure, as described further below.

As shown most clearly by the partially transparent view of FIG. 3, a plastics portion 20 is attached to the metal member 11, partially overlying the metal member 11 and partially extending beyond one long edge of the metal member 11. A part 14 of the metal member 11 is not overlaid by the plastics portion 20 and is thus exposed. Various thermoplastics may be used for the plastics portion 20, for example polycarbonate, ABS, polystyrene or polycarbonate/ABS resins. In the present example, the plastics portion 20 is overmoulded to the metal member 11. The metal member 11 has two cross-fill holes 15,16 through which the plastics material fills to help retain the plastics portion 20 to the metal member 11 after moulding. The plastics portion 20 also grips the metal member 11 by forming around the edge of the metal member 11. A hole 24 is formed through the plastics portion 20, which is sized to accommodate the finger or thumb of an operator to aid the operation of the handle 10.

The handle 10 also comprises a latch 21 situated at the opposite end of the handle 10 to the pivot hole 12. The latch 21 is formed from the plastics material of the plastics portion 20 and comprises an arm 22 projecting from the main body of the plastics portion 20 generally in a direction perpendicular to the longitudinal extent of the handle 10. The natural resiliency of the plastics material allows the arm 22 to be deflected to the side, towards the pivot end of the handle 10. The arm 22 has a locking tab 23 extending from its surface from the side away from the pivot end of the handle 10, allowing the handle 10 to be locked into position, as described further below.

The plastics portion 20 may have a wall thickness of about 0.3 mm or more. In the present example, the overall thickness of the plastics portion 20 is generally about 4.5 mm. Thus, the overall thickness of the handle 10 is generally also about 4.5 mm. Optionally, the plastics portion 20 may be locally thicker in the region of the hole and/or latch 21, up to a maximum preferred local thickness of 12.7 mm, allowing a better grip for the user. This allows the handle 10 to be used with modules where there is very little space available to accommodate a handle. For example, the handle 10 may be used for a module in accordance with the Storage Bridge Bay (SBB) specification. The SBB specification is a forthcoming industry-wide specification for a standardised controller module and controller module bay. Among other things, the SBB specification defines the size of the controller modules, and allocates an area on the face of the modules for connectors. Under the SBB specification, there is little free height space on the face of the module that can be used to accommodate a handle. In practice, the available height is limited to a maximum of no more than about 4.5 mm. The handle 10 of the present example is therefore particularly suitable for a SBB controller module.

FIGS. 4 and 5 show the handle 10 attached to a module 30. The module 30 is receivable in a storage enclosure (not shown) along an insertion direction 31. The module 30 has an external face 32 which is accessible when the module 30 is received in the storage enclosure and contains connectors allowing external connection to be made to the module, for example by a host device. The face of the module 30 opposite the external face 32 contains connectors (not shown) by which the module 30 connects to corresponding connectors on the midplane of the storage enclosure when the module 30 is fully received in the storage enclosure.

The module 30 has a slot 33 in its external face 32, extending across its width and sized to receive the exposed part 14 of the metal member 11 of the handle 10. The metal member 11 is pivotally attached to the module 30 in the slot 33 via a pin 34 extending through a hole 35 in the top face of the module 30 and the pivot hole 12 in the metal member 11. This allows the handle 10 to pivot between its closed position (as shown in FIG. 4), where the handle 10 is up against the module face 32 with the exposed part of the metal member 11 almost fully received in the slot 33, and its open position (not shown), where the handle 10 pivots through approximately 90 degrees from its closed position to assume a position close to perpendicular to the module face 32.

A locking member 40 is attached to the module 30 to provide a cooperating surface for the latch 21 to latch with. In the present example, the locking member 40 is made of plastics material. Part of the locking member 40 is disposed in the slot 33 of the module 30 and fastened therein by fasteners 36,37 extending through holes 38,39 in the top face of the module 30. The locking member 40 has a recess 41. When the handle 10 is in the closed position, the locking tab 23 is located in the recess 41 and butts against the wall of the recess 41, thereby preventing the handle 10 from pivoting open without intervention from the user.

As can be seen from FIG. 4, when the handle 10 is in the closed position, the camming projections 13a,13b extend out of the slot 33 beyond the side face of the module 30. When the module 30 is in its received position within the storage enclosure, the projections 13a,13b engage with a cooperating feature within the enclosure (not shown). When the handle 10 is then pivoted into or out of its closed position, the projections 13a,13b are made to bear against the cooperating feature, allowing the module 30 to be cammed into or out of its received position in the enclosure.

Thus to remove the module 30 from the enclosure, the user first applies a lateral force to the arm 22 to cause the locking tab 23 to move out of the recess 41 of the locking member 40. This frees the handle 10 to pivot away from its closed position. The user then pivots the handle 10 outwards towards its open position, for example by inserting a digit into the hole 24 in the handle 10 and applying an outward force. Once the locking tab 23 has moved beyond the recess 41 of the locking member 40, the force applied to the arm 22 can be relaxed, whereupon the resiliency of the plastics causes the arm 22 to return to its normal position. As the handle 10 is pivoted away from its closed position, the camming projections 13a,13b bear against the cooperating feature of the enclosure, such that a leveraging force is applied to the module 30 over a few mm of travel to overcome the separation force of the internal connectors between the module 30 and the midplane of the enclosure. Thus the module 30 is smoothly levered out of its received position in the enclosure.

As the handle 10 is pivoted further towards its open position, the projections 13a,13b progress inwards, withdrawing into the slot 33, thereby disengaging from the cooperating feature of the enclosure. This allows the module 30 to be fully withdrawn from the enclosure by pulling on the handle 10.

The sequence for inserting the module 30 is similar to that of removing the module 30 but in reverse. The module 30 is slid into the bay in the enclosure until it is almost home. The user then pivots the handle 10 inwards to its closed position, which in the process causes the projections 13a,13b to engage with the cooperating feature of the enclosure and lever the module 30 home. The locking tab 23 has a sloped inner surface to allow it to slide over the leading edge of the locking member 40, deflecting the arm 22 until the locking tab 23 has slid past the leading edge, whereupon the resiliency of the plastics material causes the arm 22 to spring back and position the locking tab 23 in the recess 41. The handle 10 is thereby put in its closed position, locking the module 30 in place in the enclosure.

The plastics portion 20 of the handle 10 provides an ergonomically suitable and comfortable grip for the user. The natural resiliency of the plastics material can be used to provide a simple construction for the latch 21. The metal member 11 of the handle 10 gives strength and stiffness to the handle 10, which is needed for the leveraging action, whilst allowing the handle 10 to be thin. This in turn allows the slot 33 in the face 32 of the module 30 to be thin. This helps minimise the area of the external face 32 that is taken up by the handle 10, allowing more space for connectors, indicators, etc. This also helps provide a simple construction for the handle 10. For example the metal member 11 can be formed by stamping sheet metal or alternatively by being cast, and the plastics portion 20 can then be overmoulded to the sheet metal. In addition, the plastics material can be colour coded, or otherwise coded, to match the module type. This allows easy identification of the module 30 by an operator.

Embodiments of the present invention have been described with particular reference to the examples illustrated. However, it will be appreciated that variations and modifications may be made to the examples described within the scope of the present invention. For instance, in another example, an individual module 30 may have two or more handles 10 attached to it. Where two handles 10 are used, the handles 10 may be positioned side-by-side, one for each side of the module 30, allowing the module 30 to be cammed into and out of its received position in the enclosure at both sides of the module 30.

1. A module receivable within a data storage device enclosure, the module comprising:
a module body; and,
a handle arranged to lever the module into or out of its received position in a said data storage device enclosure, wherein the handle has a plastics portion that can be gripped by a user to operate the handle, and a metal portion by which the handle is attached to the module body.

2. A module according to claim 1, comprising:
a latch formed from the plastics portion of the handle; and,
a locking member on the module body,
wherein with the handle in a first position relative to the module body, the handle is constrained in position by the latch latching to the locking member.

3. A module according to claim 1, wherein the metal portion is pivotally mounted to the module body.

4. A module according to claim 1, comprising at least one camming part on the metal portion for camming the module into or out of its received position in a said data storage device enclosure upon operation of the handle.

5. A module according to claim 1, wherein the metal portion is made from sheet metal having a thickness of between about 0.5 mm and 3.5 mm.

6. A module according to claim 1, wherein the handle has an overall thickness of less than about 12.7 mm.

7. A module according to claim 1, wherein the handle has an overall thickness of less than about 4.5 mm.

8. A module according to claim 1, wherein the plastics portion is overmoulded to the metal portion.

9. A module according to claim 1, wherein the plastics portion is colour coded to allow the module to be identified.

10. A method of positioning a module into or out of a received position in a data storage device enclosure, the module comprising a module body and a handle, the handle comprising a plastics portion that can be gripped by a user to operate the handle, and a metal portion by which the handle is attached to the module body, the method comprising:
gripping the plastics portion; and,
operating the handle to lever the module into or out of its received position in a said data storage device enclosure.

11. A method according to claim 10, the method comprising operating a latch formed from the plastics portion of the handle to latch to a latch member on the module body, so as to constrain or release the handle when the handle is in a first position.
